(19) United States
(12) Patent Application Publication
(10) Pub. No.: US 2009/0133859 A1
(43) Pub. Date: May 28, 2009

(54) COOLING SYSTEM, MOTOR VEHICLE EQUIPPED WITH COOLING SYSTEM, AND CONTROL METHOD OF COOLING SYSTEM

(76) Inventors: Yusuke Suzuki, Aichi-ken (JP); Yoshiaki Kikuchi, Aichi-ken (JP); Tetsuya Ishihara, Aichi-ken (JP)

Correspondence Address: SUGHRUE MION, PLLC, 2100 PENNSYLVANIA AVENUE, N.W., SUITE 800, WASHINGTON, DC, 20037, US

(21) Appl. No.: 12/295,212

(22) PCT Filed: Mar. 22, 2007
(86) PCT No.: PCT/JP2007/055805

§ 371 Date: Sep. 29, 2008

(30) Foreign Application Priority Data
Mar. 28, 2006 (JP) 2006-088406

(51) Int. Cl. B60H 1/00; F04D 27/00

(52) U.S. Cl. 165/121; 417/1

(57) ABSTRACT

A cooling system of the invention used to cool down a battery switches over an effective air blow mode between an inside air intake mode of taking in the inside air (the air in a passenger compartment) and directly blowing the intake air to the battery and an A/C intake mode of taking in the air cooled down by an air conditioner and blowing the cooled intake air to the battery. Upon the requirement for accelerated cooling of the battery (requirement for the A/C intake mode), the cooling system estimates a battery cooling power W1 in the inside air intake mode based on an inside temperature Tin and a vehicle speed V (drive-related noise), while estimating a battery cooling power W2 in the A/C intake mode based on an air conditioner outlet temperature Tac, the vehicle speed V, and an A/C air volume Qac as an air volume required for the air conditioner (steps S140 to S170). The cooling mode having the greater estimated battery cooling power is then selected as the effective air blow mode.

### TECHNICAL FIELD

The present invention relates to a cooling system configured to cool down an accumulator mounted on a motor vehicle, as well as a motor vehicle equipped with such a cooling system and a control method of such a cooling system.

### BACKGROUND ART

One proposed structure of a cooling system mounted on a motor vehicle switches over the position of a damper to change over the air blow pathway between an air flow path of taking in the air inside or outside of a passenger compartment of the motor vehicle and blowing the intake air to a battery and an air flow path of taking in the air cooled down by an evaporator and blowing the cooled intake air to the battery and cool down the battery (see, for example, Patent Documents 1 and 2). This prior art cooling system switches over the position of the damper based on the temperature of the battery, in order to keep the battery in an adequate temperature range.

Patent Document 1; Japanese Patent Laid-Open No. 2005-93434

Patent Document 2: Japanese Patent Laid-Open No. 2005-254974

### DISCLOSURE OF THE INVENTION

In the cooling system of this prior art structure, the driver and the other passengers recognize the driving noise of a blower fan for blowing the air to the battery to cool down the battery as the unusual noise. The driver and the other passengers are generally not informed of the operation of cooling down the battery. The occurrence of unusual noise in the course of cooling down the battery thus makes the driver and the other passengers feel odd and uncomfortable.

In the cooling system, the motor vehicle equipped with the cooling system, and the control method of the cooling system, there would thus be a demand for adequately cooling down a battery or an accumulator while effectively preventing the driver and the other passengers from feeling odd and uncomfortable by the occurrence of unusual noise in the course of cooling down the battery or the accumulator.

The present invention accomplishes at least part of the demand mentioned above and the other relevant demands by the following configurations applied to the cooling system, the motor vehicle equipped with the cooling system, and the control method of the cooling system.

According to one aspect, the invention is directed to a first cooling system constructed to cool down an accumulator mounted on a motor vehicle and includes:

an air conditioner configured to condition the air in a passenger compartment of the motor vehicle;

an air blower driven in multiple different air blow modes, which include a first air blow mode of taking in the air either inside the passenger compartment or outside the passenger compartment and directly blowing the intake air to the accumulator and a second air blow mode of driving the air conditioner with an increased air volume relative to an air volume required for conditioning the air in the passenger compartment and of taking in part of the air cooled down by the air conditioner to blow the cooled intake air to the accumulator;

an air blow mode switchover module configured to switch over an effective air blow mode between the multiple different air blow modes;

a temperature-relevant parameter detector configured to detect a temperature-relevant parameter reflecting temperature of the accumulator;

a noise level detection-estimation module configured to detect or estimate a noise level in the passenger compartment; and

a controller configured to select one of the multiple different air blow modes as the effective air blow mode based on the detected temperature-relevant parameter and the detected or estimated noise level and to control the air blower and the air blow mode switchover module to cool down the accumulator in the selected air blow mode.

The first cooling system according to this aspect of the invention selects one of the multiple air blow modes as the effective air blow mode based on the temperature-relevant parameter reflecting the temperature of the accumulator and the noise level in the passenger compartment, and controls the air blower and the air blow mode switchover module to cool down the accumulator in the selected air blow mode. The multiple air blow modes include the first air blow mode of taking in the air either inside the passenger compartment or outside the passenger compartment and directly blowing the intake air to the accumulator and the second air blow mode of driving the air conditioner with the increased air volume relative to the air volume required for conditioning the air in the passenger compartment and of taking in part of the air cooled down by the air conditioner to blow the cooled intake air to the accumulator. The unusual noise occurring in the course of cooling down the accumulator is sufficiently masked according to the noise level in the passenger compartment. The air blower and the air blow mode switchover module are controlled according to the temperature-relevant parameter and the noise level in the passenger compartment. This arrangement of the cooling system adequately cools down the accumulator, while effectively preventing the driver and the other passengers from feeling odd and uncomfortable by the unusual noise occurring in the course of cooling down the accumulator.

In one preferable application of the first cooling system according to this aspect of the invention, the first air blow mode is adjusted to blow the air to the accumulator with a target air volume that has a decreasing tendency with a decrease of the detected or estimated noise level. The second air blow mode is adjusted to blow the air to the accumulator with a target air volume that has a decreasing tendency with a decrease of the detected or estimated noise level and is smaller than the target air volume in the first air blow mode. When the detected temperature-relevant parameter is in a state requiring accelerated cooling of the accumulator, the controller selects an air blow mode of enabling accelerated cooling of the accumulator between the multiple different air blow modes based on the detected or estimated noise level, and controls the air blower and the air blow mode switchover module to cool down the accumulator in the selected air blow mode. The cooling system of this arrangement enables the more accelerated cooling of the accumulator in a specific range of not making the driver or the other passengers feel odd or uncomfortable. In one preferable embodiment of the first cooling system of this application, the first air blow mode is set to enable more accelerated cooling of the accumulator than the second air blow mode, when the detected or estimated noise level is lower than a preset reference level. The controller selects the first air blow mode at the detected or estimated noise level of lower than the preset reference level, while selecting the second air blow mode at the detected or estimated noise level of not lower than the preset reference level.

In another preferable application of the first cooling system according to the above aspect of the invention, the second air blow mode drives the air conditioner with a total air volume as a sum of the air volume required for conditioning the air in the passenger compartment and a target air volume to be blown to the accumulator, and takes in part of the air cooled down by the air conditioner to blow the cooled intake air to the accumulator with the target air volume. This arrangement reduces the potential effect on the air conditioning in the passenger compartment in the course of blowing the air to the accumulator in the second air blow mode. In one preferable embodiment of the first cooling system of this application, the second air blow mode is adjusted to blow the air to the accumulator with the target air volume that has a decreasing tendency with a decrease in air volume required for conditioning the air in the passenger compartment. When the detected temperature-relevant parameter is in a state requiring accelerated cooling of the accumulator, the controller selects an air blow mode of enabling accelerated cooling of the accumulator between the multiple different air blow modes based on the air volume required for conditioning the air in the passenger compartment and controls the air blower and the air blow mode switchover module to cool down the accumulator in the selected air blow mode. The cooling system of this embodiment enables the more accelerated cooling of the accumulator according to the air volume required for conditioning the air in the passenger compartment in a specific range of not making the driver or the other passengers feel odd or uncomfortable.

In still another preferable application of the first cooling system according to the above aspect of the invention, when the detected temperature-relevant parameter is in a state requiring accelerated cooling of the accumulator, the controller selects an air blow mode of enabling accelerated cooling of the accumulator between the multiple different air blow modes based on temperatures of the intake air taken in the respective multiple air blow modes and controls the air blower and the air blow mode switchover module to cool down the accumulator in the selected air blow mode. The cooling system of this arrangement ensures adequate selection of the air blow mode to enable accelerated cooling of the accumulator.

In one preferable embodiment of the first cooling system of the invention, the noise level detection-estimation module has a vehicle speed detector configured to detect a vehicle speed of the motor vehicle, and detects or estimates the noise level in the passenger compartment, based on the detected vehicle speed. In one preferable application of this embodiment, the first air blow mode and the second air blow mode are adjusted to make a cooling power in the first air blow mode equal to or greater than a cooling power in the second air blow mode at the detected vehicle speed of not higher than a preset reference speed and to make the cooling power in the second air blow mode greater than the cooling power in the first air blow mode at the detected vehicle speed of higher than the preset reference speed. The controller selects the first air blow mode at the detected vehicle speed of not higher than the preset reference speed and controls the air blower and the air blow mode switchover module to cool down the accumulator in the selected first air blow mode, while selecting the second air blow mode at the detected vehicle speed of higher than the preset reference speed and controlling the air blower and the air blow mode switchover module to cool down the accumulator in the selected second air blow mode.

The first cooling system of the invention may be mounted on a motor vehicle equipped with an internal combustion engine. The noise level detection-estimation module has an engine rotation speed detector configured to detect a rotation speed of the internal combustion engine, and detects or estimates the noise level in the passenger compartment, based on the detected rotation speed of the internal combustion engine.

The first cooling system of the invention may be mounted on a motor vehicle equipped with an audio output module configured to output sound with an adjustable volume in the passenger compartment. The noise level detection-estimation module detects or estimates the noise level in the passenger compartment, based on a volume adjustment condition of the audio output module.

According to another aspect, the invention is also directed to a second cooling system constructed to cool down an accumulator mounted on a motor vehicle and includes: an air conditioner configured to condition the air in a passenger compartment of the motor vehicle;

an air blower driven in multiple different air blow modes, which include a first air blow mode of taking in the air either inside the passenger compartment or outside the passenger compartment and directly blowing the intake air to the accumulator and a second air blow mode of driving the air conditioner with a total air volume as a sum of an air volume required for conditioning the air in the passenger compartment and a target air volume to be blown to the accumulator and of taking in part of the air cooled down by the air conditioner to blow the cooled intake air to the accumulator with the target air volume;

an air blow mode switchover module configured to switch over an effective air blow mode between the multiple different air blow modes;

a temperature-relevant parameter detector configured to detect a temperature-relevant parameter reflecting temperature of the accumulator; and

a controller configured to select one of the multiple different air blow modes as the effective air blow mode based on the detected temperature-relevant parameter and the air volume required for conditioning the air in the passenger compartment and to control the air blower and the air blow mode switchover module to cool down the accumulator in the selected air blow mode.

The second cooling system according to this aspect of the invention selects one of the multiple air blow modes as the effective air blow mode based on the temperature-relevant parameter reflecting the temperature of the accumulator and the air volume required for conditioning the air in the passenger compartment, and controls the air blower and the air blow mode switchover module to cool down the accumulator in the selected air blow mode. The multiple air blow modes include the first air blow mode of taking in the air either inside the passenger compartment or outside the passenger compartment and directly blowing the intake air to the accumulator and the second air blow mode of driving the air conditioner with the total air volume as the sum of the air volume required for conditioning the air in the passenger compartment and the target air volume to be blown to the accumulator and of taking in part of the air cooled down by the air conditioner to blow the cooled intake air to the accumulator with the target air volume. The cooling system of this arrangement adequately cools down the accumulator according to the air volume required for conditioning the air in the passenger compartment in a specific range of not making the driver or the other passengers feel odd or uncomfortable. The air conditioner is driven with the total air volume as the sum of the air volume required for conditioning the air in the passenger compartment and the target air volume to be blown to the accumulator. This arrangement reduces the potential effect on the air conditioning in the passenger compartment in the course of blowing the air to the accumulator in the second air blow mode.

In one preferable application of the second cooling system according to this aspect of the invention, the second air blow mode is adjusted to blow the air to the accumulator with the target air volume that has a decreasing tendency with a decrease in air volume required for conditioning the air in the passenger compartment. The first air blow mode is adjusted to enable more accelerated cooling of the accumulator than the second air blow mode, when the air volume required for conditioning the air in the passenger compartment is less than a preset reference value. When the detected temperature-relevant parameter is in a state requiring accelerated cooling of the accumulator, the controller selects the first air blow mode at the air volume required for conditioning the air in the passenger compartment that is less than the preset reference value, while selecting the second air blow mode at the air volume required for conditioning the air in the passenger compartment that is not less than the preset reference value.

In either of the first cooling system or the second cooling system of the invention, the controller may select the first air blow mode when the detected temperature-relevant parameter is in a state not requiring accelerated cooling of the accumulator. This arrangement prevents frequent activation of the second air blow mode, thus improving the energy efficiency.

In either of the first cooling system or the second cooling system of the invention, the accumulator may be designed to transmit electric power to and from a driving motor mounted on the motor vehicle.

According to still another aspect, the invention is further directed to a motor vehicle equipped with either the first cooling system or the second cooling system, which is constructed to cool down an accumulator mounted on the vehicle and has any of the arrangements described above. The first cooling system basically has: an air conditioner configured to condition the air in a passenger compartment of the motor vehicle; an air blower driven in multiple different air blow modes, which include a first air blow mode of taking in the air either inside the passenger compartment or outside the passenger compartment and directly blowing the intake air to the accumulator and a second air blow mode of driving the air conditioner with an increased air volume relative to an air volume required for conditioning the air in the passenger compartment and of taking in part of the air cooled down by the air conditioner to blow the cooled intake air to the accumulator; an air blow mode switchover module configured to switch over an effective air blow mode between the multiple different air blow modes; a temperature-relevant parameter detector configured to detect a temperature-relevant parameter reflecting temperature of the accumulator; a noise level detection-estimation module configured to detect or estimate a noise level in the passenger compartment; and a controller configured to select one of the multiple different air blow modes as the effective air blow mode based on the detected temperature-relevant parameter and the detected or estimated noise level and to control the air blower and the air blow mode switchover module to cool down the accumulator in the selected air blow mode. The second cooling system basically has: an air conditioner configured to condition the air in a passenger compartment of the motor vehicle; an air blower driven in multiple different air blow modes, which include a first air blow mode of taking in the air either inside the passenger compartment or outside the passenger compartment and directly blowing the intake air to the accumulator and a second air blow mode of driving the air conditioner with a total air volume as a sum of an air volume required for conditioning the air in the passenger compartment and a target air volume to be blown to the accumulator and of taking in part of the air cooled down by the air conditioner to blow the cooled intake air to the accumulator with the target air volume; an air blow mode switchover module configured to switch over an effective air blow mode between the multiple different air blow modes; a temperature-relevant parameter detector configured to detect a temperature-relevant parameter reflecting temperature of the accumulator; and a controller configured to select one of the multiple different air blow modes as the effective air blow mode based on the detected temperature-relevant parameter and the air volume required for conditioning the air in the passenger compartment and to control the air blower and the air blow mode switchover module to cool down the accumulator in the selected air blow mode.

The vehicle according to this aspect of the invention is equipped with the cooling system of the invention having any of the arrangements discussed above. The motor vehicle accordingly has the effects similar to those of the cooling system discussed above and adequately cools down the accumulator while preventing the driver and the other passengers from feeling odd and uncomfortable by the unusual noise occurring in the course of cooling down the accumulator.

According to another aspect, the invention is also directed to a first control method of a cooling system, which includes: an air conditioner configured to condition the air in a passenger compartment of a motor vehicle; an air blower driven in multiple different air blow modes, which include a first air blow mode of taking in the air either inside the passenger compartment or outside the passenger compartment and directly blowing the intake air to an accumulator mounted on the motor vehicle and a second air blow mode of driving the air conditioner with an increased air volume relative to an air volume required for conditioning the air in the passenger compartment and of taking in part of the air cooled down by the air conditioner to blow the cooled intake air to the accumulator; and an air blow mode switchover module configured to switch over an effective air blow mode between the multiple different air blow modes. The control method selects one of the multiple different air blow modes as the effective air blow mode based on a temperature-relevant parameter reflecting temperature of the accumulator and a noise level in the passenger compartment and controls the air blower and the air blow mode switchover module to cool down the accumulator in the selected air blow mode.

The first control method of the cooling system according to this aspect of the invention selects one of the multiple air blow modes as the effective air blow mode based on the temperature-relevant parameter reflecting the temperature of the accumulator and the noise level in the passenger compartment, and controls the air blower and the air blow mode switchover module to cool down the accumulator in the selected air blow mode. The multiple air blow modes include the first air blow mode of taking in the air either inside the passenger compartment or outside the passenger compartment and directly blowing the intake air to the accumulator and the second air blow mode of driving the air conditioner with the increased air volume relative to the air volume required for conditioning the air in the passenger compartment and of taking in part of the air cooled down by the air conditioner to blow the cooled intake air to the accumulator. The unusual noise occurring in the course of cooling down the accumulator is sufficiently masked according to the noise level in the passenger compartment. The air blower and the air blow mode switchover module are controlled according to the temperature-relevant parameter and the noise level in the passenger compartment. The first control method of this arrangement adequately cools down the accumulator, while effectively preventing the driver and the other passengers from feeling odd and uncomfortable by the unusual noise occurring in the course of cooling down the accumulator.

According to still another aspect, the invention is further directed to a second control method of a cooling system, which includes: an air conditioner configured to condition the air in a passenger compartment of a motor vehicle; an air blower driven in multiple different air blowmodes, which include a first air blow mode of taking in the air either inside the passenger compartment or outside the passenger compartment and directly blowing the intake air to an accumulator mounted on the motor vehicle and a second air blow mode of driving the air conditioner with a total air volume as a sum of an air volume required for conditioning the air in the passenger compartment and a target air volume to be blown to the accumulator and of taking in part of the air cooled down by the air conditioner to blow the cooled intake air to the accumulator with the target air volume; and an air blow mode switchover module configured to switch over an effective air blow mode between the multiple different air blow modes. The control method selects one of the multiple different air blow modes as the effective air blow mode based on a temperature-relevant parameter reflecting temperature of the accumulator and the air volume required for conditioning the air in the passenger compartment and controls the air blower and the air blow mode switchover module to cool down the accumulator in the selected air blow mode.

The second control method of the cooling system according to this aspect of the invention selects one of the multiple air blow modes as the effective air blow mode based on the temperature-relevant parameter reflecting the temperature of the accumulator and the air volume required for conditioning the air in the passenger compartment, and controls the air blower and the air blow mode switchover module to cool down the accumulator in the selected air blow mode. The multiple air blow modes include the first air blow mode of taking in the air either inside the passenger compartment or outside the passenger compartment and directly blowing the intake air to the accumulator and the second air blow mode of driving the air conditioner with the total air volume as the sum of the air volume required for conditioning the air in the passenger compartment and the target air volume to be blown to the accumulator and of taking in part of the air cooled down by the air conditioner to blow the cooled intake air to the accumulator with the target air volume. The second control method of this arrangement adequately cools down the accumulator according to the air volume required for conditioning the air in the passenger compartment in a specific range of not making the driver or the other passengers feel odd or uncomfortable. The air conditioner is driven with the total air volume as the sum of the air volume required for conditioning the air in the passenger compartment and the target air volume to be blown to the accumulator. This arrangement reduces the potential effect on the air conditioning in the passenger compartment in the course of blowing the air to the accumulator in the second air blow mode.

### BRIEF DESCRIPTION OF THE DRAWINGS

FIG. 1 schematically illustrates the configuration of a hybrid vehicle 20 in one embodiment of the invention;

FIG. 2 shows the schematic structure of a cooling system 60 for a battery 46 in the embodiment;

FIG. 3 is a flowchart showing a battery cooling routine executed by a hybrid electronic control unit 70 in the embodiment;

FIG. 4 shows one example of a cooling mode setting map;

FIG. 5 shows one example of a map representing a variation in target battery air volume Qb* in an inside air intake mode against vehicle speed V;

FIG. 6 shows one example of a map representing variations in target battery air volume Qb* in an A/C intake mode against the vehicle speed V with regard to various values of an A/C air volume Qac;

FIG. 7 is a flowchart showing one modified flow of the battery cooling routine in one modified example;

FIG. 8 shows variations in cooling power for the battery 46 against the vehicle speed V in the inside air intake mode and in the A/C intake mode;

FIG. 9 is a flowchart showing another modified flow of the battery cooling routine in another modified example;

FIG. 10 shows a variation in cooling power for the battery 46 against the A/C air volume Qac in the A/C intake mode relative to the cooling power in the inside air intake mode;

FIG. 11 is a flowchart showing still another modified flow of the battery cooling routine in still another modified example; and

FIG. 12 shows a process of setting a reference speed Vref based on the vehicle speed V and the A/C air volume Qac.

### BEST MODES OF CARRYING OUT THE INVENTION

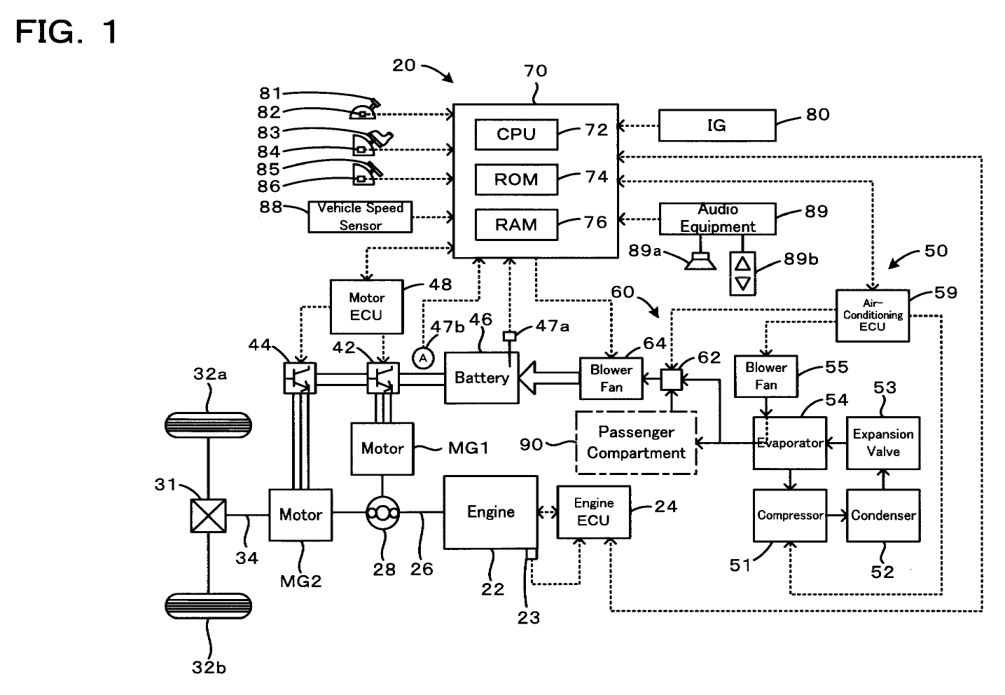

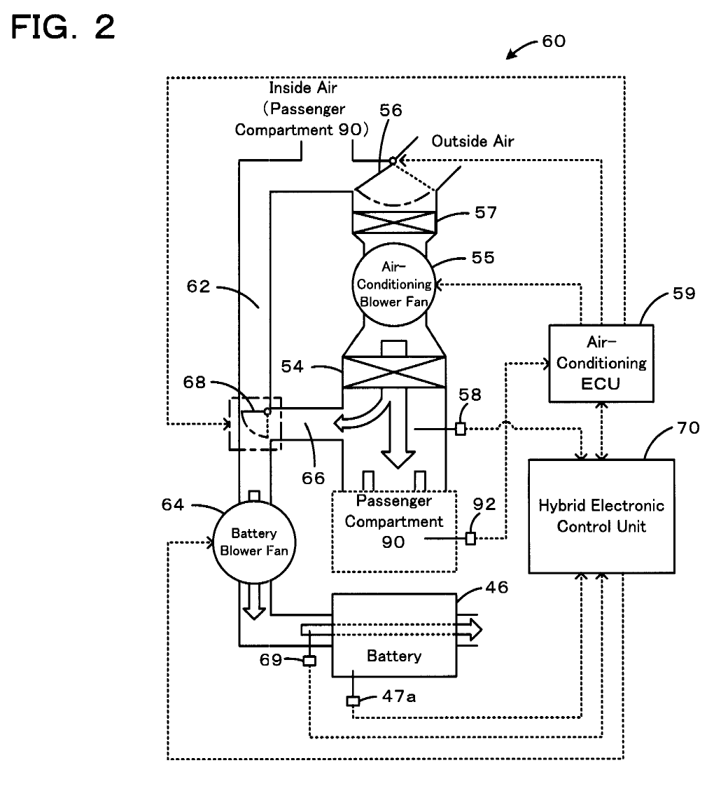

FIG. 1 schematically illustrates the configuration of a hybrid vehicle 20 in one embodiment of the invention. FIG. 2 shows the schematic structure of a cooling system 60 for a battery 46 in the embodiment. As illustrated in FIG. 1, the hybrid vehicle 20 of the embodiment has an engine 22, a planetary gear mechanism 28 having a carrier connected to a crankshaft 26 of the engine 22 and a ring gear connected to a driveshaft 34 that is linked with drive wheels 32a and 32b via a differential gear 31, a motor MG1 connected with a sun gear of the planetary gear mechanism 28 and designed to have power generation capability, a motor MG2 designed to input and output power from and to a driveshaft 34, the battery 46 arranged to transmit electric power to and from the motors MG1 and MG2 via inverters 42 and 44, an air conditioner 50 configured to condition the air in a passenger compartment 90, the cooling system 60 configured to use the air cooled down by the air conditioner 50 and thereby cool down the battery 46, audio equipment 89 incorporated in a console panel in front of the driver's seat in the passenger compartment 90 and having a tuner (not shown), a speaker 89a for audio output, and a volume control button 89b, and a hybrid electronic control unit 70 configured to control the driving system of the vehicle and the cooling system 60 of the embodiment.

The engine 22 is under operation control of an engine electronic control unit (hereafter referred to as engine ECU) 24. The operation control includes, for example, fuel injection control, ignition control, and intake air flow regulation. The engine ECU 24 inputs signals from various sensors designed to measure and detect the operating conditions of the engine 22, for example, a crank position from a crank position sensor 23 attached to the crankshaft 26 of the engine 22. The engine ECU 24 establishes communication with the hybrid electronic control unit 70 to drive and control the engine 22 in response to control signals received from the hybrid electronic control unit 70 and to output data regarding the operating conditions of the engine 22 to the hybrid electronic control unit 70 according to the requirements.

Both the motors MG1 and MG2 are driven and controlled by a motor electronic control unit (hereafter referred to as motor ECU) 48. The motor ECU 48 inputs various signals required for driving and controlling the motors MG1 and MG2, for example, signals representing rotational positions of rotors in the motors MG1 and MG2 from rotational position detection sensors (not shown) and signals representing phase currents to be applied to the motors MG1 and MG2 from current sensors (not shown). The motor ECU 48 outputs switching control signals to the inverters 42 and 44. The motor ECU 48 establishes communication with the hybrid electronic control unit 70 to drive and control the motors MG1 and MG2 in response to control signals received from the hybrid electronic control unit 70 and to output data regarding the operating conditions of the motors MG1 and MG2 to the hybrid electronic control unit 70 according to the requirements.

As shown in FIGS. 1 and 2, the air conditioner 50 has a compressor 51 configured to compress a coolant to high-temperature, high-pressure gas, a condenser 52 configured to cool down the compressed coolant with the outside air to high-pressure liquid, an expansion valve 53 configured to abruptly expand the cooled coolant to low-temperature, low-pressure mist, an evaporator 54 configured to evaporate the coolant to low-temperature, low-pressure gas by heat exchange between the low-temperature, low-pressure coolant and the air, and an air-conditioning blower fan 55 configured to blow the air cooled down by the heat exchange of the evaporator 54 to the passenger compartment 90. The air-conditioning blower fan 55 is driven to take in the air from an inside air-outside air switchover damper 56 via a filter 57 and to cool down the intake air by the evaporator 54 and blow the cooled intake air to the passenger compartment 90.

The air conditioner 50 is under control of an air-conditioning electronic control unit (hereafter referred to as air-conditioning ECU) 59. The air-conditioning ECU 59 inputs an inside temperature Tin or temperature in the passenger compartment 90 from a temperature sensor 92. The air-conditioning ECU 59 outputs driving signals to the compressor 51, to the air-conditioning blower fan 55, to the inside air-outside air switchover damper 56, and to a mode switchover damper 68 (explained below). The air-conditioning ECU 59 establishes communication with the hybrid electronic control unit 70 to drive and control air conditioner 50 in response to control signals received from the hybrid electronic control unit 70 and to output data regarding the operating conditions of the air conditioner 50 to the hybrid electronic control unit 70 according to the requirements.

The cooling system 60 is arranged to take in the air from the passenger compartment 90 and directly blow the intake air to the battery 46, so as to cool down the battery 46 (hereafter this cooling mode is referred to as inside air intake mode). The cooling system 60 is also arranged to alternately take in the air cooled down by the evaporator 54 of the air conditioner 50 and blow the cooled intake air to the battery 46, so as to cool down the battery 46 (hereafter this cooling mode is referred to as A/C intake mode). As shown in FIG. 2, the cooling system 60 has an air conduit 62 arranged to connect the passenger compartment 90 (inside air) with the battery 46, a battery blower fan 64 provided on the air conduit 62 to blow the intake air to the battery 46, a branch pipe 66 arranged to blow part of the air flowed from the air-conditioning blower fan 55 through the evaporator 54 to the upstream of the battery blower fan 64 in the air conduit 62, and the mode switchover damper 68 provided at a joint of the air conduit 62 and the branch pipe 66 to selectively block the inside air or block the branch pipe 66.

The hybrid electronic control unit 70 is constructed as a microcomputer including a CPU 72, a ROM 74 configured to store processing programs, a RAM 76 configured to temporarily store data, input and output ports (not shown), and a communication port (not shown). The hybrid electronic control unit 70 inputs, via its input port, a battery temperature Tb or temperature of the battery 46 from a temperature sensor 47a, a charge-discharge electric current Ib from a current sensor 47b attached to an output terminal of the battery 46, an air conditioner outlet temperature Tac from a temperature sensor 58 located in the vicinity of an air outlet of the air conditioner 50, an intake air temperature Tbi from a temperature sensor 69 provided in the vicinity of an entrance to the battery 46 in the air conduit 62, an ignition signal from an ignition switch 80, a gearshift position SP or a current setting position of a gearshift lever 81 from a gearshift position sensor 82, an accelerator opening Acc or the driver's depression amount of the accelerator pedal 83 from an accelerator pedal position sensor 84, a brake pedal position BP or the driver's depression amount of the brake pedal 85 from a brake pedal position sensor 86, a vehicle speed V from a vehicle speed sensor 88, and an operation signal from the volume control button 89b. The hybrid electronic control unit 70 outputs driving signals to the battery blower fan 64 and to the other relevant elements via its output port. The hybrid electronic control unit 70 makes connection with the engine ECU 24, the motor ECU 48, and the air-conditioning ECU 59 via its communication port to transmit various control signals and data to and from the engine ECU 24, the motor ECU 48, and the air-conditioning ECU 59 as mentioned previously.

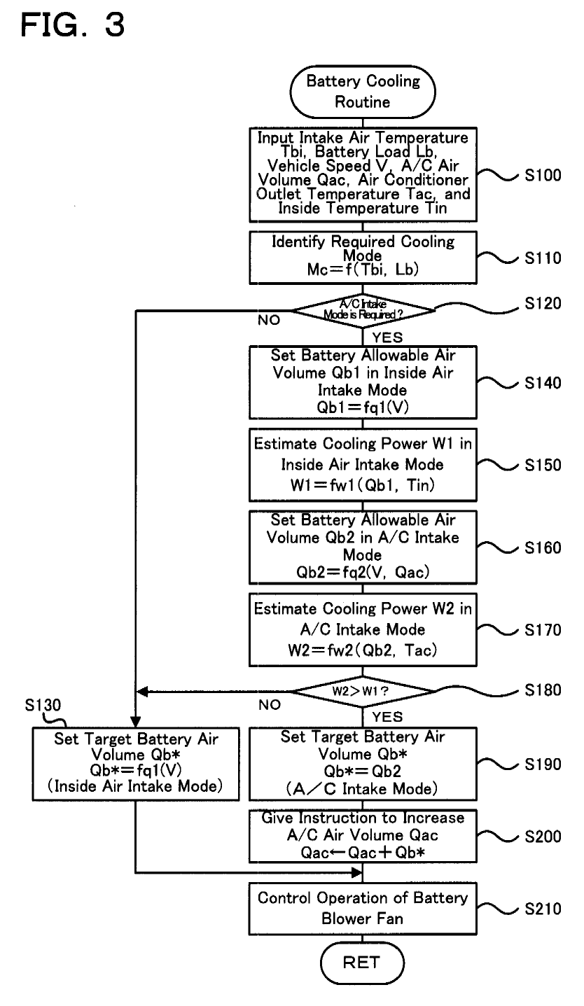

The following describes the operations of the hybrid vehicle 20 of the embodiment having the configuration discussed above, especially a series of operations to cool down the battery 46. FIG. 3 is a flowchart showing a battery cooling routine executed by the hybrid electronic control unit 70. This routine is repeatedly performed at preset time intervals (for example, at every several ten msec) when the battery temperature Tb measured by the temperature sensor 47a is not lower than a preset reference temperature (for example, 50° C.).

In the battery cooling routine, the CPU 72 of the hybrid electronic control unit 70 first inputs various data required for control, for example, the intake air temperature Tbi from the temperature sensor 69, a battery load Lb of the battery 46, the vehicle speed V from the vehicle speed sensor 88, an A/C air volume Qac required to condition the air in the passenger compartment 90 by the air conditioner 50, the air conditioner outlet temperature Tac from the temperature sensor 58, and the inside temperature Tin of the passenger compartment 90 (step S100). The battery load Lb of the battery 46 may be obtained by averaging a preset number of computed values of charge-discharge electric power of the battery 46 (the product of the square of the charge-discharge electric current Ib measured by the current sensor 47b and an internal resistance of the battery 46). The A/C air volume Qac of the air conditioner 50 is set based on the user's set air volume as the air flow to be blown out to the passenger compartment 90, the user's set temperature, and the inside temperature Tin from the temperature sensor 92 and is input from the air-conditioning ECU 59 by communication. The inside temperature Tin is measured by the temperature sensor 92 and is input from the air-conditioning ECU 59 by communication. The air conditioner outlet temperature Tac measured by the temperature sensor 58 may be replaced with the user's set temperature of the air conditioner 50.

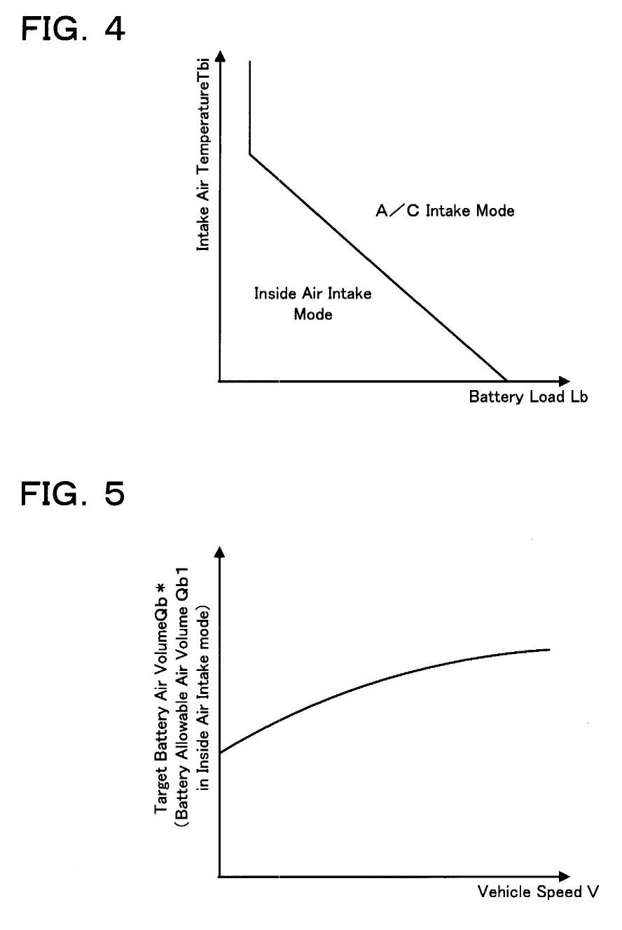

After the data input, the CPU 72 identifies a required cooling mode, based on the input intake air temperature Tbi and the input battery load Lb (step S110). The required cooling mode is identified according to the intake air temperature Tbi and the battery load Lb with referring to a cooling mode setting map. One example of the cooling mode setting map is shown in FIG. 4. The intake air temperature Tbi and the battery load Lb are parameters significantly affecting the temperature of the battery 46 (battery temperature Tb). The higher intake air temperature Tbi and the greater battery load Lb lead to a significant increase in temperature of the battery 46 and thereby require accelerated cooling of the battery 46. The A/C cooling mode is thus required in this case. The lower intake air temperature Tbi and the smaller battery load Lb, on the other hand, lead to a relatively small increase in temperature of the battery 46 and thereby do not require accelerated cooling of the battery 46. The inside air intake mode is thus required in this case.

Upon the requirement of the inside air intake mode (step S120), the CPU 72 sets a target battery air volume Qb* to be blown to the battery 46 based on the input vehicle speed V (step S130) and controls the operation of the battery blower fan 64 with the set target battery air volume Qb* (step S210). The battery cooling routine is then terminated. A concrete procedure of setting the target battery air volume Qb* in the inside air intake mode in this embodiment provides and stored in advance a variation in target battery air volume Qb* against the vehicle speed V as a map in the ROM 74 and reads the target battery air volume Qb* corresponding to the given vehicle speed V from the stored map. One example of this map is shown in FIG. 5. The higher vehicle speed V leads to the larger drive-related noise and gives the greater background noise to the driver and the other passengers. The driver or the other passengers are generally not informed of the operation of the battery blower fan 64. The operation of the battery blower fan 64 at a high rotation speed may thus generate the large driving noise and cause the driver and the other passengers to feel odd and uncomfortable. In order to effectively mask the driving noise of the battery blower fan 64 with the background noise increasing with an increase in vehicle speed V, the operation of the battery blower fan 64 is allowed to have the greater target battery air volume Qb* at the higher vehicle speed V. The battery blower fan 64 is thus driven to cool down the battery 46 in a specific range of not making the driver or the other passengers feel odd or uncomfortable.

Upon the requirement of the A/C intake mode (step S120), on the other hand, the CPU 72 sets a battery allowable air volume Qb1 as an air volume allowed for the battery blower fan 64 in the inside air intake mode, based on the input vehicle speed V (step S140), and estimates a battery cooling power W1 in the inside air intake mode, based on the set battery allowable air volume Qb1 and the input inside temperature Tin (step S150). The battery allowable air volume Qb1 is set as an acceptable air volume to be blown to the battery 46 in the inside air intake mode in a specific range of not making the driver or the other passengers feel odd or uncomfortable. This battery allowable air volume Qb1 is identical with the target battery air volume Qb* set at step S130. A concrete procedure of the embodiment computes the estimated battery cooling power W1 in the inside air intake mode according to Equation (1) given below:

W1=(Tb*−Tin)·Qb1 (1)

where Tb* denotes a preset target temperature of the battery 46 (for example, 40° C. or 45° C.). Instead of such computation of the estimated battery cooling power W1, another available procedure may provide and store in advance variations in battery cooling power W1 against the inside temperature Tin and the battery allowable air volume Qb1 as a map in the ROM 74 and read the estimated battery cooling power W1 corresponding to the given inside temperature Tin and the given battery allowable air volume Qb1 from the map.

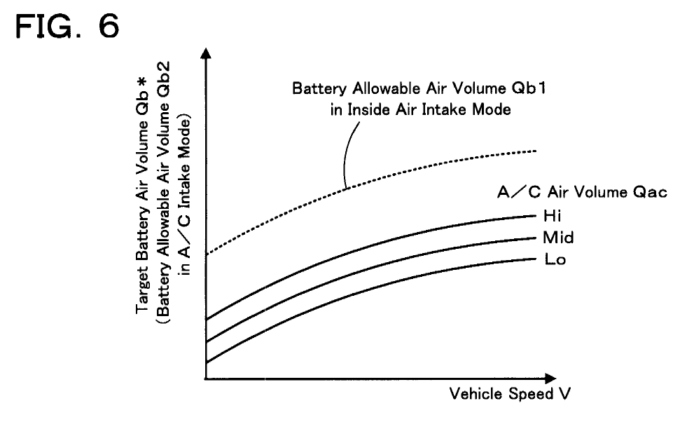

The CPU 72 subsequently sets a battery allowable air volume Qb2 as an air volume allowed for the battery blower fan 64 in the A/C intake mode, based on the input vehicle speed V and the input A/C air volume Qac of the air conditioner 50 (step S160), and estimates a battery cooling power W2 in the A/C intake mode, based on the set battery allowable air volume Qb2 and the input air conditioner outlet temperature Tac (step S170). The battery allowable air volume Qb2 is set as an acceptable air volume to be blown to the battery 46 in the A/C intake mode in a specific range of not making the driver or the other passengers feel odd or uncomfortable. A concrete procedure of setting the battery allowable air volume Qb2 in the A/C intake mode in the embodiment provides and stores in advance variations in battery allowable air volume Qb2 against the vehicle speed V with regard to multiple values of the A/C air volume Qac as a map in the ROM 74 and reads the battery allowable air volume Qb2 corresponding to the given vehicle speed V and the given A/C air volume Qac from the stored map. One example of this map is shown in FIG. 6. As shown in this map, the battery allowable air volume Qb2 in the A/C intake mode is smaller than the battery allowable air volume Qb1 in the inside air intake mode at an identical value of the vehicle speed V. As discussed later, in the A/C intake mode, the air-conditioning blower fan 55 for the air conditioner 50 is driven with the A/C air volume Qac increased by the battery allowable air volume Qb2 (the target battery air volume Qb*). The driving noise of the air-conditioning blower fan 55 is thus greater than the driving noise of the battery blower fan 64 in the A/C intake mode. This increases the potential that the driver and the other passengers feel odd and uncomfortable. A concrete procedure of the embodiment computes the estimated battery cooling power W2 in the A/C intake mode according to Equation (2) given below:

W2=(Tb*−Tac)·Qb2 (2)

Instead of such computation of the estimated battery cooling power W2, another available procedure may provide and store in advance variations in battery cooling power W2 against the air conditioner outlet temperature Tac and the battery allowable air volume Qb2 as a map in the ROM 74 and read the estimated battery cooling power W2 corresponding to the given air conditioner outlet temperature Tac and the given battery allowable air volume Qb2 from the map. The battery allowable air volume Qb2 in the A/C intake mode is set smaller than the battery allowable air volume Qb1 in the inside air intake mode, in order to prevent the driver and the other passengers from feeling odd and uncomfortable as mentioned above. Such setting may cause the cooling power in the inside air intake mode to be greater than the cooling power in the A/C intake mode according to some conditions of the vehicle speed V, the A/C air volume Qac, the inside temperature Tin, and the air conditioner outlet temperature Tac.

The estimated battery cooling power W1 in the inside air intake mode is then compared with the estimated battery cooling power W2 in the A/C intake mode (step S180). When the estimated battery cooling power W2 in the A/C intake mode is greater than the estimated battery cooling power W1 in the inside air intake mode, the CPU 72 selects the A/C intake mode and sets the battery allowable air volume Qb2 set at step S160 to the target battery air volume Qb* (step S190) and gives an instruction to the air-conditioning ECU 59 to increase the A/C air volume Qac by the set target battery air volume Qb* (step S200). The CPU 72 then controls the operation of the battery blower fan 64 with the set target battery air volume Qb* (step S210) and terminates the battery cooling routine. The air-conditioning ECU 59 receives the instruction of increasing the A/C air volume Qac by the set target battery air volume Qb* and controls the operation of the air-conditioning blower fan 55 with the A/C air volume Qac increased by the target battery air volume Qb*. While the battery blower fan 64 is driven with the target battery air volume Qb*, the air cooled by the evaporator 54 is blown at the A/C air volume Qac to the passenger compartment 90. Such control accordingly does not affect the air conditioning in the passenger compartment 90.

When the estimated battery cooling power W2 in the A/C intake mode is not greater than the estimated battery cooling power W1 in the inside air intake mode, on the other hand, The CPU 72 selects the inside air intake mode and sets the target battery air volume Qb* (battery allowable air volume Qb1) corresponding to the input vehicle speed V with referring to the map of FIG. 5 as explained previously (step S130). The CPU 72 then controls the operation of the battery blower fan 64 with the set target battery air volume Qb* (step S210) and terminates the battery cooling routine. As mentioned above, the target battery air volume Qb* in the A/C intake mode is set smaller than the target battery air volume Qb* in the inside air intake mode at the identical value of the vehicle speed V. Such setting may cause the estimated battery cooling power W2 in the A/C intake mode to be not greater than the estimated battery cooling power W1 in the inside air intake mode according to some condition of the vehicle speed V. In this case, the inside air intake mode is selected, irrespective of the requirement for the A/C intake mode. Such control enables accelerated cooling of the battery 46, while reducing the energy consumption required for the A/C intake mode.

In the hybrid vehicle 20 of the embodiment described above, upon the requirement for the A/C intake mode according to the intake air temperature Tbi and the battery load Lb, the battery cooling power W1 in the inside air intake mode is estimated, based on the inside temperature Tin and the battery allowable air volume Qb1 allowed corresponding to the vehicle speed V (drive-related noise). The battery cooling power W2 in the A/C intake mode is estimated, based on the air conditioner outlet temperature Tac and the battery allowable air volume Qb2 allowed corresponding to the vehicle speed V and the A/C air volume Qac. The cooling mode having the greater cooling power is selected for the air blow to the battery 46 between the inside air intake mode and the A/C intake mode. This enables accelerated cooling of the battery 46. Such cooling control adequately cools down the battery 46, while desirably preventing the driver and the other passengers from feeling odd and uncomfortable due to the unusual noise potentially occurring in the course of cooling the battery 46. When the estimated battery cooling power W2 in the A/C intake mode is not greater than the estimated battery cooling power W1 in the inside air intake mode, the inside air intake mode is selected to reduce the energy consumption.

Upon the requirement for the A/C intake mode, the hybrid vehicle 20 of the embodiment estimates the battery cooling power W1 in the inside air intake mode based on the inside temperature Tin and the battery allowable air volume Qb1 allowed corresponding to the vehicle speed V (drive-related noise), estimates the battery cooling power W2 in the A/C intake mode based on the air conditioner outlet temperature Tac and the battery allowable air volume Qb2 allowed corresponding to the vehicle speed V and the A/C air volume Qac, and selects the cooling mode having the greater cooling power between the inside air intake mode and the A/C intake mode. One modification may simply select the cooling mode based on the inside temperature Tin, the vehicle speed V, and the air conditioner outlet temperature Tac, and the A/C air volume Qac without estimating the battery cooling powers W1 and W2 in the respective cooling modes. Another modification may select the cooling mode based on only the inside temperature Tin, the vehicle speed V, and the air conditioner outlet temperature Tac without taking into account the A/C air volume Qac.

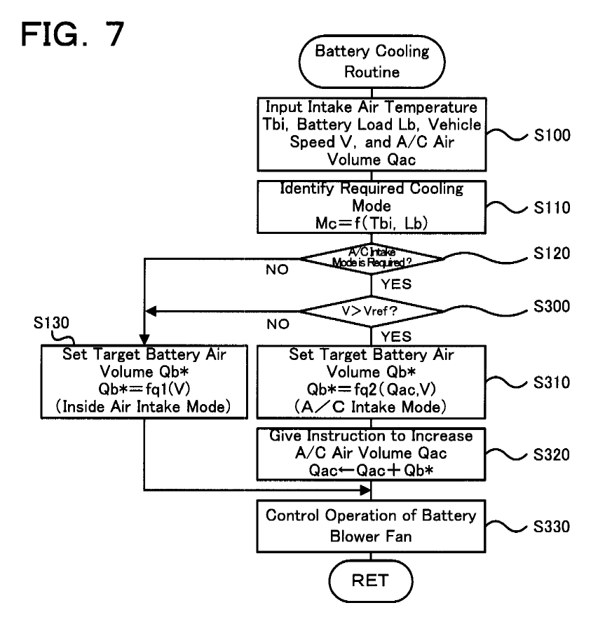

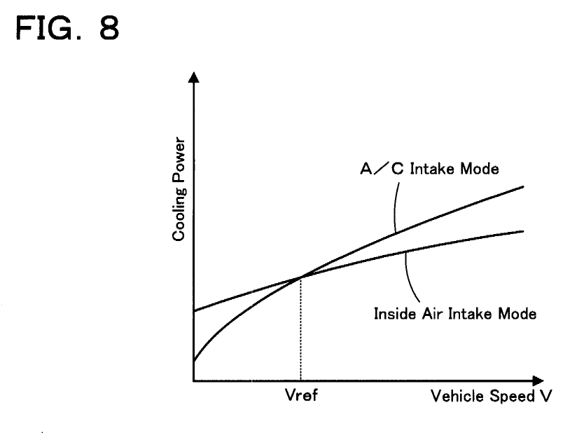

The hybrid vehicle 20 of the embodiment selects the cooling mode based on the inside temperature Tin, the vehicle speed V, the air conditioner outlet temperature Tac, and the A/C air volume Qac. In one modification, the cooling mode may be selected based on only the vehicle speed V. The flowchart of FIG. 7 shows a modified flow of the battery cooling routine in this modification. The same processing steps in the modified routine of FIG. 7 as those in the routine of FIG. 3 are expressed by the same step numbers and are not specifically explained here. In the modified battery cooling routine of FIG. 7, upon the requirement for the A/C intake mode at step S120, the CPU 72 compares the vehicle speed V with a preset reference speed Vref (step S300). When the vehicle speed V is not higher than the preset reference speed Vref, the inside air intake mode is selected as the more effective cooling mode to enable accelerated cooling of the battery 46, compared with the A/C intake mode. The CPU 72 accordingly sets the target battery air volume Qb* corresponding to the vehicle speed V with referring to the map of FIG. 5 (step S130). When the vehicle speed V is higher than the preset reference speed Vref, on the other hand, the A/C intake mode is selected as the more effective cooling mode to enable accelerated cooling of the battery 46, compared with the inside air intake mode. The CPU 72 accordingly sets the target battery air volume Qb* corresponding to the vehicle speed V and the A/C air volume Qac with referring to the map of FIG. 6 (step S310) and gives an instruction to the air conditioning ECU 59 to increase the A/C air volume Qac by the set target battery air volume Qb* (step S320). The CPU 72 then controls the operation of the battery blower fan 64 with the set target battery air volume Qb* (step S330) and terminates the battery cooling routine. FIG. 8 shows variations in cooling power for the battery 46 against the vehicle speed V in the inside air intake mode and in the A/C intake mode. As shown in FIG. 8, the cooling power in the inside air intake mode and the cooling power in the A/C intake mode are adequately adjusted to prevent the driver and the other passengers from feeling odd and uncomfortable by the driving noise of the battery blower fan 64 and the air-conditioning blower fan 55. At the vehicle speed V of or below the preset reference speed Vref, the cooling power in the inside air intake mode is adjusted to be not less than the cooling power in the A/C intake mode. At the vehicle speed V over the preset reference speed Vref, on the other hand, the cooling power in the A/C intake mode is adjusted to be greater than the cooling power in the inside air intake mode.

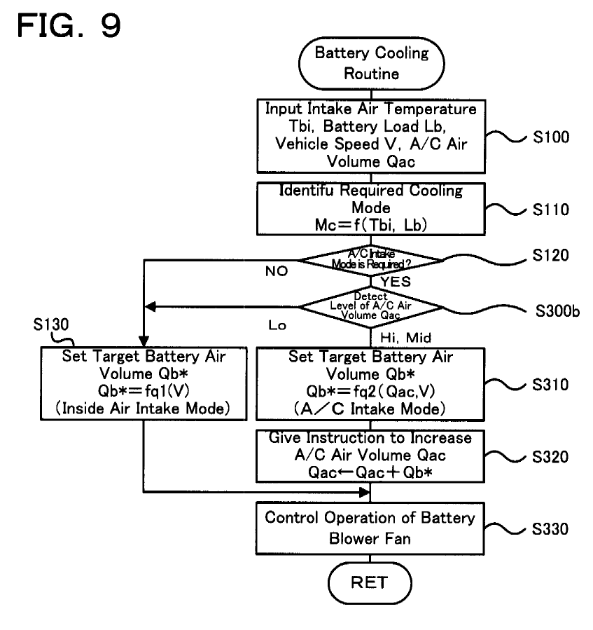

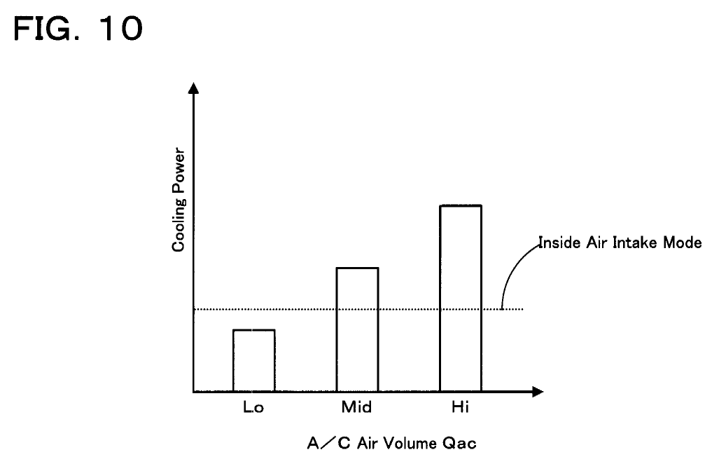

The hybrid vehicle 20 of the embodiment selects the cooling mode based on the inside temperature Tin, the vehicle speed V, the air conditioner outlet temperature Tac, and the A/C air volume Qac. In another modification, the cooling mode may be selected based on only the A/C air volume Qac. The flowchart of FIG. 9 shows a modified flow of the battery cooling routine in this modification. The same processing steps in the modified routine of FIG. 9 as those in the routine of FIG. 7 are expressed by the same step numbers and are not specifically explained here. In the modified battery cooling routine of FIG. 9, upon the requirement for the A/C intake mode at step S120, the CPU 72 detects the level of the A/C air volume Qac (step S300b). When the level of the A/C air volume Qac is ‘Lo’ (low), the inside air intake mode is selected as the more effective cooling mode to enable accelerated cooling of the battery 46, compared with the A/C intake mode (steps S130 and S330). When the level of the A/C air volume Qac is either ‘Hi’ (high) or ‘Mid’ (middle), on the other hand, the A/C intake mode is selected as the more effective cooling mode to enable accelerated cooling of the battery 46, compared with the inside air intake mode (steps S310 to S330). FIG. 10 shows a variation in cooling power for the battery 46 against the A/C air volume Qac in the A/C intake mode relative to the cooling power in the inside air intake mode. As shown in FIG. 10, the cooling power in the inside air intake mode and the cooling power in the A/C intake mode are adequately adjusted to prevent the driver and the other passengers from feeling odd and uncomfortable by the driving noise of the battery blower fan 64 and the air-conditioning blower fan 55. At the ‘Lo’ level of the A/C air volume Qac, the cooling power in the inside air intake mode is adjusted to be greater than the cooling power in the A/C intake mode. At the ‘Mid’ level or the ‘Hi’ level of the A/C air volume Qac, on the other hand, the cooling power in the A/C intake mode is adjusted to be greater than the cooling power in the inside air intake mode.

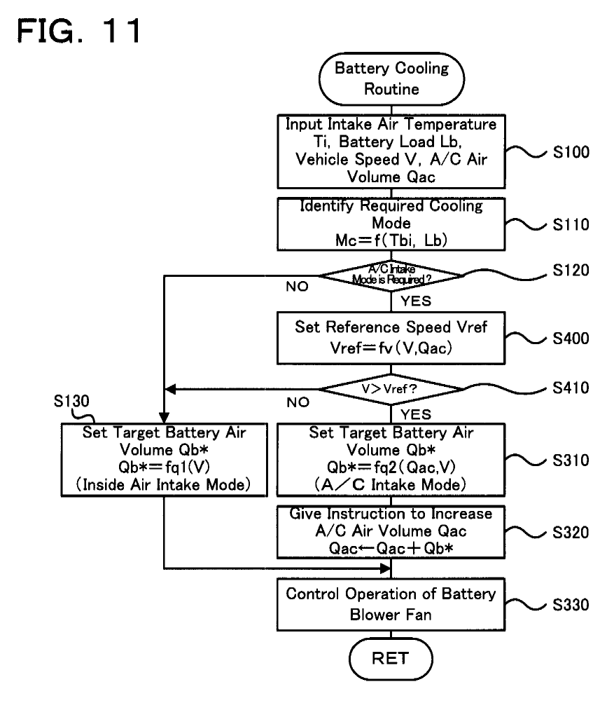

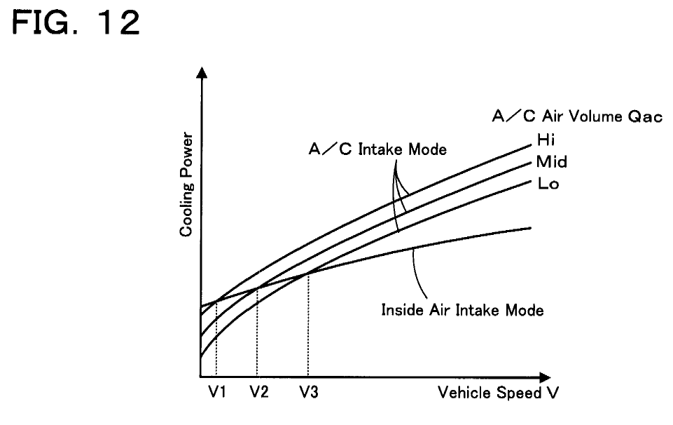

The hybrid vehicle 20 of the embodiment selects the cooling mode based on the inside temperature Tin, the vehicle speed V, the air conditioner outlet temperature Tac, and the A/C air volume Qac. In still another modification, the cooling mode may be selected based on the vehicle speed V and the A/C air volume Qac. The flowchart of FIG. 11 shows a modified flow of the battery cooling routine in this modification. The same processing steps in the modified routine of FIG. 11 as those in the routine of FIG. 7 are expressed by the same step numbers and are not specifically explained here. In the modified battery cooling routine of FIG. 11, upon the requirement for the A/C intake mode at step S120, the CPU 72 sets a reference speed Vref for selection between the inside air intake mode and the A/C intake mode based on the vehicle speed V and the A/C air volume Qac (step S400). At the vehicle speed V of not higher than the set reference speed Vref, the inside air intake mode is selected as the more effective cooling mode to enable accelerated cooling of the battery 46, compared with the A/C intake mode (steps S130 and S330). At the vehicle speed V of higher than the set reference speed Vref, on the other hand, the A/C intake mode is selected as the more effective cooling mode to enable accelerated cooling of the battery 46, compared with the inside air intake mode (steps S310 to S330). FIG. 12 shows a process of setting the reference speed Vref based on the vehicle speed V and the A/C air volume Qac. As shown in FIG. 12, the reference speed Vref is set to a value V1 at the ‘Hi’ level of the A/C air volume Qac, to a value V2 at the ‘Mid’ level of the A/C air volume Qac, and to a value V3 at the ‘Lo’ level of the A/C air volume Qac.

The hybrid vehicle 20 of the embodiment uses the vehicle speed V as a parameter reflecting the noise in the passenger compartment 90 (background noise) or a noise estimation parameter. The vehicle speed V may be replaced by any other suitable parameter reflecting the noise in the passenger compartment 90 (background noise). Available examples of the parameter reflecting the noise in the passenger compartment 90 (background noise) include a rotation speed Ne of the engine 22 computed from a signal representing the crank position detected by the crank position sensor 23, a volume level adjusted by the volume control button 89b of the audio equipment 89, and a noise level actually detected by a microphone located in the passenger compartment 90.

The hybrid vehicle 20 of the embodiment identifies the required cooling mode, based on the intake air temperature Tbi and the battery load Lb. The required cooling mode may be identified based on only the intake air temperature Tbi, based on only the battery load Lb, or based on another suitable parameter, for example, the battery temperature Tb or its increase rate.

The hybrid vehicle 20 of the embodiment has the inside air intake mode of taking in the inside air (the air in the passenger compartment 90) and directly blowing the intake air to the battery 46 and the A/C intake mode of taking in the air cooled down by the air conditioner 50 (evaporator 54) and blowing the cooled intake air to the battery 46, as the available options of the cooling mode Mc in the cooling system 60. An outside air intake mode of taking in the outside air and blowing the intake air to the battery 46 may be provided in place of or in addition to the inside air intake mode.

The embodiment regards the cooling system 60 as one application of the invention to cool down the battery 46, which is arranged to transmit electric power to and from the motors MG1 and MG2 in the hybrid vehicle 20 equipped with the engine 22, the planetary gear mechanism 28, and the motors MG1 and MG2. This is, however, not restrictive in any sense. The cooling system of the invention may be applied to cool down a battery or another accumulator arranged to transmit electric power to and from a driving motor in a hybrid vehicle of another configuration or may be applied to cool down a battery or another accumulator arranged to transmit electric power to and from a motor in an electric vehicle equipped with only the motor as the driving power source. The cooling system of the invention may also be applied to cool down an accumulator used for an auto start in a motor vehicle having engine auto stop and auto start functions.

The embodiment and its modified examples discussed above are to be considered in all aspects as illustrative and not restrictive. There may be many other modifications, changes, and alterations without departing from the scope or spirit of the main characteristics of the present invention.

### INDUSTRIAL APPLICABILITY

The technique of the present invention is preferably applied to the manufacturing industries of the cooling systems and the motor vehicles.

1. A cooling system constructed to cool down an accumulator mounted on a motor vehicle, the cooling system comprising:
an air conditioner configured to condition the air in a passenger compartment of the motor vehicle;
a noise level detection-estimation module configured to detect or estimate a noise level in the passenger compartment;
an air blower driven in multiple different air blow modes, which include a first air blow mode of taking in the air either inside the passenger compartment or outside the passenger compartment and directly blowing the intake air to the accumulator with a target air volume that has a decreasing tendency with a decrease of the detected or estimated noise level and a second air blow mode of driving the air conditioner with a total air volume as a sum of an air volume required for conditioning the air in the passenger compartment and a target air volume that has a decreasing tendency with a decrease of the detected or estimated noise level and is smaller than the target air volume in the first air blow mode and of taking in part of the air cooled down by the air conditioner to blow the cooled intake air to the accumulator with the target air volume;
an air blow mode switchover module configured to switch over an effective air blow mode between the multiple different air blow modes;
a temperature-relevant parameter detector configured to detect a temperature-relevant parameter reflecting temperature of the accumulator;
a controller configured to, when the detected temperature-relevant parameter is in a state requiring accelerated cooling of the accumulator, select an air blow mode of enabling accelerated cooling of the accumulator between the multiple different air blow modes based on the detected temperature-relevant parameter and the detected or estimated noise level and to control the air blower and the air blow mode switchover module to cool down the accumulator in the selected air blow mode.

2. (canceled)

3. The cooling system in accordance with claim 1, wherein the first air blow mode is set to enable more accelerated cooling of the accumulator than the second air blow mode, when the detected or estimated noise level is lower than a preset reference level, and
the controller selects the first air blow mode at the detected or estimated noise level of lower than the preset reference level, while selecting the second air blow mode at the detected or estimated noise level of not lower than the preset reference level.

4. The cooling system in accordance with claim 1, wherein the second air blow mode drives the air conditioner with a total air volume as a sum of the air volume required for conditioning the air in the passenger compartment and a target air volume to be blown to the accumulator, and takes in part of the air cooled down by the air conditioner to blow the cooled intake air to the accumulator with the target air volume.

5. The cooling system in accordance with claim 1, wherein the second air blow mode is adjusted to blow the air to the accumulator with the target air volume that has a decreasing tendency with a decrease in air volume required for conditioning the air in the passenger compartment, and
when the detected temperature-relevant parameter is in a state requiring accelerated cooling of the accumulator, the controller selects an air blow mode of enabling accelerated cooling of the accumulator between the multiple different air blow modes based on the air volume required for conditioning the air in the passenger compartment and controls the air blower and the air blow mode switchover module to cool down the accumulator in the selected air blow mode.

6. The cooling system in accordance with claim 1, wherein when the detected temperature-relevant parameter is in a state requiring accelerated cooling of the accumulator, the controller selects an air blow mode of enabling accelerated cooling of the accumulator between the multiple different air blow modes based on temperatures of the intake air taken in the respective multiple air blow modes and controls the air blower and the air blow mode switchover module to cool down the accumulator in the selected air blow mode.

7. The cooling system in accordance with claim 1, wherein the noise level detection-estimation module has a vehicle speed detector configured to detect a vehicle speed of the motor vehicle, and
the noise level detection-estimation module detects or estimates the noise level in the passenger compartment, based on the detected vehicle speed.

8. The cooling system in accordance with claim 1, wherein the first air blow mode and the second air blow mode are adjusted to make a cooling power in the first air blow mode equal to or greater than a cooling power in the second air blow mode at the detected vehicle speed of not higher than a preset reference speed and to make the cooling power in the second air blow mode greater than the cooling power in the first air blow mode at the detected vehicle speed of higher than the preset reference speed, and
the controller selects the first air blow mode at the detected vehicle speed of not higher than the preset reference speed and controls the air blower and the air blow mode switchover module to cool down the accumulator in the selected first air blow mode, while selecting the second air blow mode at the detected vehicle speed of higher than the preset reference speed and controlling the air blower and the air blow mode switchover module to cool down the accumulator in the selected second air blow mode.

9. The cooling system in accordance with claim 1, the cooling system being mounted on a motor vehicle equipped with an internal combustion engine,
wherein the noise level detection-estimation module has an engine rotation speed detector configured to detect a rotation speed of the internal combustion engine, and
the noise level detection-estimation module detects or estimates the noise level in the passenger compartment, based on the detected rotation speed of the internal combustion engine.

10. The cooling system in accordance with claim 1, the cooling system being mounted on a motor vehicle equipped with an audio output module configured to output sound with an adjustable volume in the passenger compartment,
wherein the noise level detection-estimation module detects or estimates the noise level in the passenger compartment, based on a volume adjustment condition of the audio output module.

11. The cooling system in accordance with claim 1, wherein the controller selects the first air blow mode when the detected temperature-relevant parameter is in a state not requiring accelerated cooling of the accumulator.

12. The cooling system in accordance with claim 1, wherein the accumulator is designed to transmit electric power to and from a driving motor mounted on the motor vehicle.

13. A cooling system constructed to cool down an accumulator mounted on a motor vehicle, the cooling system comprising:
an air conditioner configured to condition the air in a passenger compartment of the motor vehicle;
an air blower driven in multiple different air blow modes, which include a first air blow mode of taking in the air either inside the passenger compartment or outside the passenger compartment and directly blowing the intake air to the accumulator and a second air blow mode of driving the air conditioner with a total air volume as a sum of an air volume required for conditioning the air in the passenger compartment and a target air volume to be blown to the accumulator and of taking in part of the air cooled down by the air conditioner to blow the cooled intake air to the accumulator with the target air volume wherein the second air blow mode is adjusted to blow the air to the accumulator with the target air volume that has a decreasing tendency with a decrease in air volume required for conditioning the air in the passenger compartment, and the first air blow mode is adjusted to enable more accelerated cooling of the accumulator than the second air blow mode, when the air volume required for conditioning the air in the passenger compartment is less than a preset reference value;
an air blow mode switchover module configured to switch over an effective air blow mode between the multiple different air blow modes;
a temperature-relevant parameter detector configured to detect a temperature-relevant parameter reflecting temperature of the accumulator; and
a controller configured to when the detected temperature-relevant parameter is in a state requiring accelerated cooling of the accumulator, select the first air blow mode at the air volume required for conditioning the air in the passenger compartment that is less than the preset reference value, while selecting the second air blow mode at the air volume required for conditioning the air in the passenger compartment that is not less than the preset reference value and to control the air blower and the air blow mode switchover module to cool down the accumulator in the selected air blow mode.

14. (canceled)

15. The cooling system in accordance with claim 13, wherein the controller selects the first air blow mode when the detected temperature-relevant parameter is in a state not requiring accelerated cooling of the accumulator.

16. The cooling system in accordance with claim 13, wherein the accumulator is designed to transmit electric power to and from a driving motor mounted on the motor vehicle.

17. A motor vehicle equipped with the cooling system in accordance with claim 1.

18. A control method of a cooling system, the cooling system having: an air conditioner configured to condition the air in a passenger compartment of a motor vehicle; an air blower driven in multiple different air blow modes, which include a first air blow mode of taking in the air either inside the passenger compartment or outside the passenger compartment and directly blowing the intake air to an accumulator mounted on the motor vehicle with a target air volume that has a decreasing tendency with a decrease of the noise level and a second air blow mode of driving the air conditioner with a total air volume as a sum of an air volume required for conditioning the air in the passenger compartment and a target air volume that has a decreasing tendency with a decrease of the noise level and is smaller than the target air volume in the first air blow mode and of taking in part of the air cooled down by the air conditioner to blow the cooled intake air to the accumulator with the target air volume; and an air blow mode switchover module configured to switch over an effective air blow mode between the multiple different air blow modes;
when a temperature-relevant parameter reflecting temperature of the accumulator is in a state requiring accelerated cooling of the accumulator, the control method selecting an air blow mode of enabling accelerated cooling of the accumulator between the multiple different air blow modes based on a temperature-relevant parameter reflecting temperature of the accumulator and a noise level in the passenger compartment and controlling the air blower and the air blow mode switchover module to cool down the accumulator in the selected air blow mode.

19. A control method of a cooling system, the cooling system having: an air conditioner configured to condition the air in a passenger compartment of a motor vehicle; an air blower driven in multiple different air blow modes, which include a first air blow mode of taking in the air either inside the passenger compartment or outside the passenger compartment and directly blowing the intake air to an accumulator mounted on the motor vehicle and a second air blow mode of driving the air conditioner with a total air volume as a sum of an air volume required for conditioning the air in the passenger compartment and a target air volume to be blown to the accumulator and of taking in part of the air cooled down by the air conditioner to blow the cooled intake air to the accumulator with the target air volume wherein the second air blow mode is adjusted to blow the air to the accumulator with the target air volume that has a decreasing tendency with a decrease in air volume required for conditioning the air in the passenger compartment, and the first air blow mode is adjusted to enable more accelerated cooling of the accumulator than the second air blow mode when the air volume required for conditioning the air in the passenger compartment is less than a preset reference value; and an air blow mode switchover module configured to switch over an effective air blow mode between the multiple different air blow modes,
when a temperature-relevant parameter reflecting temperature of the accumulator is in a state requiring accelerated cooling of the accumulator, the control method selecting the first air blow mode at the air volume required for conditioning the air in the passenger compartment that is less than the preset reference value, while selecting the second air blow mode at the air volume required for conditioning the air in the passenger compartment that is not less than the preset reference value and controlling the air blower and the air blow mode switchover module to cool down the accumulator in the selected air blow mode.
